(19) United States
(12) Patent Application Publication
(10) Pub. No.: US 2006/0065127 A1
(43) Pub. Date: Mar. 30, 2006

(54) Liquid infusion pods containing insoluble materials

(76) Inventors: David Andrew Dalton, Loveland, OH (US); Herman William Meyer, West Harrison, IN (US); John Joseph Scarchilli, Cincinnati, OH (US); Stephen Jerome Westerkamp, Milford, OH (US); Dana Paul Gruenbacher, Fairfield, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/225,945

(22) Filed: Sep. 14, 2005

Related U.S. Application Data
(60) Provisional application No. 60/612,719, filed on Sep. 24, 2004.

(51) Int. Cl. A47J 31/00

(52) U.S. Cl. 99/279

(57) ABSTRACT

Liquid infusion pods having a fluid distribution member situated in a top plane and a liquid permeable first filter member wherein the first filter member is sealed to the fluid distribution member forming a first interior chamber that comprises a liquid dispersible material, the fluid distribution member having at least one injection nozzle protruding downward from the top plane into the interior chamber, the injection nozzle has at least one infusion port that directs fluid into the first interior chamber in a direction that is not normal to the top plane, the first filter member comprising at least first region and at least one second region wherein the permeability of the first region is different from the permeability of the second region.

### CROSS REFERENCE TO RELATED APPLICATIONS

This application claims the benefit of priority to U.S. Provisional Application Ser. No. 60/612,719, filed Sep. 24, 2004, which is herein incorporated by reference.

### BRIEF DESCRIPTION OF THE INVENTION

The present invention relates to liquid infusion pods comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, the first filter member comprising at least one first region and at least one second region wherein the permeability of the first region is different from the permeability of the second region.

### BACKGROUND OF THE INVENTION

Making coffee is a time consuming and work intensive operation. The typical coffee drinker uses a brew basket type coffee machine that requires the following process steps. The coffee pot must be rinsed and filled with clean water, the grounds used to brew the previous pot of coffee must be removed from the basket and the brew basket rinsed. Then a new filter is placed in the basket and grounds are measured and placed in the filter. This, of course, assumes that the consumer buys pre-ground coffee rather than grinding their own beans. The grounds that inevitably spill onto the counter top must be cleaned, and then the water is poured into the brewer's reservoir. The machine is turned on, and then the consumer waits. And waits. And then waits some more while the pot brews.

Often this lengthy and laborious process is carried out when the consumer wants only a single cup of coffee. Moreover, at the end of the brewing process the consumer has black coffee. Cream and sugar must be measured and added if that is how the consumer drinks their coffee.

There are options available for coffee drinkers that address the problems associated with coffee brewing, but with marginal success. For example, a single cup of coffee can be brewed with a standard brew basket brewer. But because these machines are designed for 4, 8, 10 or more cups, brewing one cup is sub-optimal and often results in wasting grounds and problems with strength control. Moreover, all of the process steps described above must be followed whether making one cup or ten. Espresso machines are another option for preparing single cup servings of a coffee like beverage. But the cleaning and filling of and espresso machine's brewing cartridge can be time consuming and messy. Espresso grounds are quite fine and need to be tightly packed. Because of the tight packing and because espresso machines brew with steam, the grounds are often difficult to remove from the cartridge when they are wet. Moreover, espresso is a concentrated form of coffee that is too strong for the tastes of many consumers, and espresso grounds are often more expensive than regular grounds. The addition of frothy cream to an espresso beverage involves a separate steam line and a separate pot of milk or cream and more work for the consumer preparing the froth and cleaning up afterwards. At the end of it all, the consumer has a delicious espresso beverage, but only after the expenditure of considerable time, energy and cost.

Finally, there is the option of visiting the local coffee house. These establishments—in general—provide an excellent cup of coffee, espresso, latte, etc., without any work on behalf of the consumer. But there is still a great deal of work that goes into the production of these beverages, and that work is included in the price. Moreover, visiting the local coffee house necessarily involves leaving your home or office or wherever it is that you wish to drink your beverage, and going somewhere else to get a cup of coffee. Currently, there are no options that allow the consumer to reduce the number of steps necessary to brew a single cup of coffee with a frothy, creamy head, do it at home or at work, and do it at a cost similar to the cost of brewing coffee at home.

Pre-dosed packets of coffee grounds in filter pods are available to simplify the coffee brewing process. But these packets are typically designed for the multi-cup brew basket coffee brewers. Thus, they are not amenable to single cup brewing. Recently, however, single cup brew pods have been introduced with a special single cup brewing machine. While these machines and their pods eliminate some of the work and mess associated with brewing a single cup of coffee, they still brew black coffee only. Thus, at best, these new machines solve only half of the problems.

Attempts have been made to supply filter pods containing sweetener and creamer ingredients. Unfortunately, these attempts have largely failed due to the difference in the type of ingredients. More specifically, coffee is brewed through a standard extraction process. Hot water, steam or both are fed onto the grounds and the coffee is extracted. Coffee flows through the filter medium leaving the spent, wet grounds behind. In general, neither the coffee nor the grounds clog the filter media.

The coffee extraction process stands in sharp contrast to the process of fluidizing a solid, granular or concentrated liquid dispersible material. Liquid dispersible materials typically include fats, oils, proteins and combinations of these ingredients that are either not water soluble or not readily soluble in water. Often this fluidization process is described as “dissolving” the creamer, but this is a misnomer because many of the creamer ingredients do not dissolve in water but are instead suspended or emulsified in water. Regardless, the presence of insoluble or slightly soluble ingredients presents a substantial problem when trying to deliver liquid dispersible materials in a pre-dosed, self-contained filter pod.

FIG. 11 illustrates one problem associated with prior attempts to make a creamer extraction pod 130. Specifically, as liquid 14 is showered down from the top—as is the case in substantially all coffee makers—through filter 122, the liquid dispersible material, illustrated as liquid dispersible material 18, is forced downward forming a packed layer 19 on bottom filter 23. Packed layer 19 clogs bottom filter 23 restricting the flow of liquid 14. Eventually, channels 21 begin to form as cracks in packed layer 19, allowing extracted liquid 115 to escape extraction pod 130. The problem is that packed layer 19 contains a substantial quantity of virgin or unextracted liquid dispersible material 18. And because extracted liquid 115 escapes through channels 21, it does not make sufficient contact with the liquid dispersible material 18 and the concentration of dispersible materials in extracted liquid 115 is likely to be well below the desired level. Moreover, channels 21 can form in a variety of places and directions. Thus, extracted liquid 115 can be forced out of the sides or top of extraction pod 130 causing additional problems, not to mention generally making a mess of the inside of the coffee brewer. Ultimately, extraction pod 130 does not work when it is filled with materials that are slightly soluble, or are water insoluble.

Moreover, the filter material used to construct such filter pods may also factor into functionality. For instance, if the filter material used to construct the pod is too flimsy, the pod may be misshapen or damaged during shipment, resulting in an unpleasant usage experience for the consumer. Additionally, many filter materials have large pores and high permeability to allow for the passage of extracted or dissolved materials from the pod during brewing. However, if the permeability of the filter material is too great, the materials within the pods may sift out of the pod during distribution, which again, can result in a messy pod and an unpleasant experience for the consumer. Furthermore, in many instances, the extraction liquid must contact the liquid dispersible materials within the pod for a minimum amount of time (e.g. “residence time”) in order to achieve the proper degree of dissolution. Once again, if the pores on the filter material are too large, the extracted liquid may exit the pod before the desired dissolution has occurred, thereby producing a beverage product that may be perceived by the consumer to be weak or tasteless.

One the other hand, the permeability of the filter material should not be so minimal as to cause an undesirable pressure build-up within the brewing device during brewing, or to effectively prevent the liquid dispersible material contained within the pod from being adequately extracted.

Without intending to be limited by theory, it is believed that as the pore size of the filter material increases, both the residence time and fines retention of the filter material decreases. Thus, it can be difficult to find a filter material that has the pore size needed to allow passage of the extracted material from the pod, while at the same time providing shape and fines retention during distribution, as well as the necessary residence time needed for proper dissolution.

As such, there exists a need for a liquid infusion pod that overcomes the problems discussed above. Specifically, the pod may be constructed of a filter material that provides both shape and fines retention, as well as achieves a residence time sufficient to provide the desired degree of dissolution. These and many other problems are solved by the infusion pods of the present invention.

### SUMMARY OF THE INVENTION

In one embodiment, the present invention relates to liquid infusion pods comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, the first filter member comprising at least one first region and at least one second region wherein the permeability of the first region is different from the permeability of the second region.

In another embodiment, the present invention relates to liquid infusion pods comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, wherein the permeability of the first filter member is less than about 250 cfm/ft².

In yet another embodiment, the present invention relates to liquid infusion pods comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, the first filter member comprising a permeability of less than about 250 cfm/ft² and at least one first region and at least one second region wherein the permeability of the first region is decreased relative to the permeability of the second region.

### BRIEF DESCRIPTION OF THE DRAWINGS

While the present application concludes with claims that distinctly define the present invention, it is believed that this invention will be better understood with reference to the drawings wherein:

FIG. 1 is a cross sectional view of an infusion pod according to the present invention;

FIG. 2 is a cross sectional view of the infusion pod of FIG. 1 further comprising an extraction pod;

FIG. 3 is a cross sectional view of a unitary infusion pod of the present invention that comprises both an extraction pod and an infusion pod and only one infusion port;

FIG. 4 is a cross sectional view of a unitary infusion pod according to the present invention wherein the liquid distribution member slopes down towards the injection nozzle allowing an extraction pod to be added with a substantially flat top;

FIG. 5 is a bottom view of the fluid extraction member of FIG. 4, that is a view looking into the flow of liquid, showing the filter supporting baffles;

FIG. 6 is a cross sectional view of an infusion pod of the present invention that has a self contained filter pod within the infusion pod;

FIG. 7 is a cross sectional view of an infusion pod of the present invention that has a deflectable injection nozzle which is shown in its first, non-protruding position;

FIG. 8 is a cross sectional view of the infusion pod of FIG. 7 showing the deflectable injection nozzle in its second, protruding position;

FIG. 9 is a cross sectional view of an infusion pod of the present invention that has a downward facing infusion nozzle and a deflection plate to change the direction of flow of the infusion liquid;

FIG. 10 is a cross sectional view of an infusion pod of the present invention that has upward facing infusion ports;

FIG. 11 is a cross sectional view of an extraction pod of the prior art that contains a liquid dispersible material;

FIG. 12 is a brewer suitable for use with the infusion pods of the present invention;

FIG. 13A is a front elevated view of one embodiment of an infusion pod having a single altered region;

FIG. 13B is a front elevated view of one embodiment of an infusion pod having more than one altered region.

### DETAILED DESCRIPTION OF THE INVENTION

Liquid Infusion Pods

The present invention is directed to infusion pods that comprise a liquid dispersible material. More specifically, there is provided herein a liquid infusion pod comprising a fluid distribution member situated in a top plane and a liquid permeable first filter member. The first filter member is sealed to the fluid distribution member forming a first interior chamber that comprises a liquid dispersible material. The fluid distribution member comprises at least one injection nozzle protruding downward from the top plane into the interior chamber. The injection nozzle has at least one infusion port that directs fluid into the first interior chamber in a direction that is not normal to the top plane.

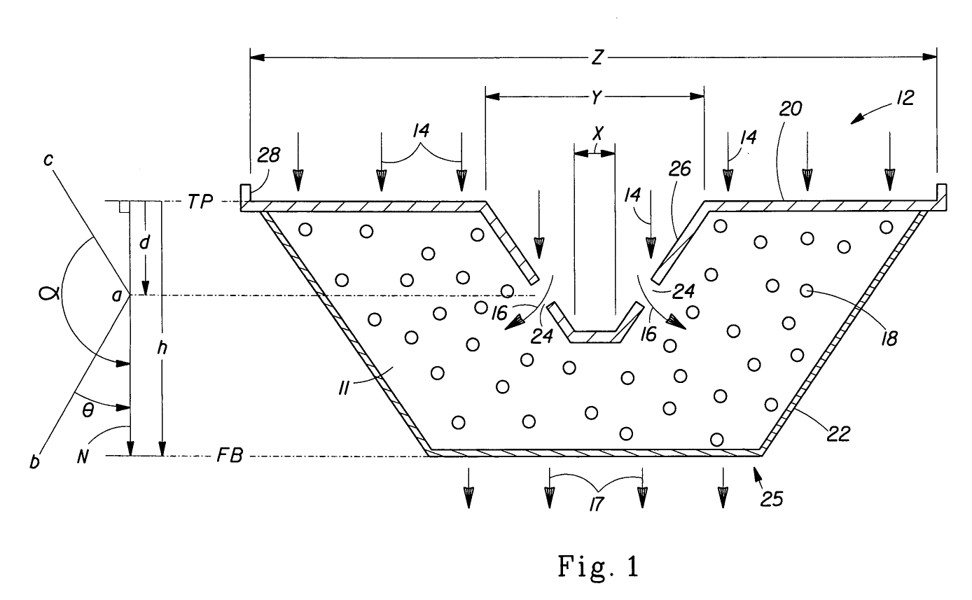

Referring now to FIG. 1 which shows liquid infusion pod 12 that comprises fluid distribution member 20 and first filter member 22 which are sealed to define first interior chamber 11. Fluid distribution member 20 comprises injection nozzle 26 and may optionally comprise end wall 28. Injection nozzle 26 comprises infusion ports 24. While two infusion ports 24 are shown in FIG. 1 it is understood that one infusion port is sufficient, likewise, three or more infusion ports can be used. The criticality of the infusion ports is best described in conjunction with the use of infusion pod 12.

Fresh liquid 14 is introduced to fluid distribution member 20 and it flows either by gravity or by an applied pressure, toward injection nozzle 26. Fresh liquid 14 collects in injection nozzle 26 and is forced through infusion ports 24, again, either due to gravity of by externally applied pressure. The size and number of infusion ports 24 must be designed such that when fresh liquid 14 flows through the infusion ports 24 is has a relatively high fluid momentum, shown in FIG. 1 as high momentum liquid 16, and it is directed away from filter bottom FB. Thus, infusion ports must be designed, in size and number, to insure that the liquid entering the first interior chamber 11 does not pack the liquid dispersible material 18, but rather fluidizes it. The fluidization is accomplished by the combination of having a relatively high momentum fluid 16 that enters the pod in a direction that is not normal N to the top plane TP of infusion pod 12.

More specifically, as shown in FIG. 1, infusion pod 12 has a top plane TP and a filter bottom FB. Normal line N is shown normal, that is 90°, from top plane TP. By “not normal” to top plane TP it is meant that infusion port 24 delivers high momentum liquid 16 to first interior chamber 11 at an angle from about 20° to about 160°, preferably from about 30° to about 150°, and more preferably from about 40° to about 140° from the point of the infusion port on a line normal to the top plane. These angles are illustrated on FIG. 1 as angles α and θ, wherein angle α is the arc swung by line ac from normal N, and wherein angle θ is the arc swung by line ab from normal N.

Distance d is the distance that infusion port 24 is below top plane TP measured along normal N. Likewise, h is the height of infusion pod 12 measured along normal N from top plane TP to filter bottom FB, and penetration p is the distance that injection nozzle 26 penetrates into first interior chamber 11 measured down from top plane TP along normal N. Height h is preferably from about 1.0 cm to about 10 cm, more preferably from about 1.5 cm to about 7.5 cm and most preferably from about 1.8 cm to about 5 cm. Penetration p is preferably at least about 20%, more preferably at least about 25% and most preferably at least about 30% of height h. Penetration p can, and preferably does, extend 100% of height h. Necessarily, distance d is always less than or equal to penetration p and d is preferably at least about 20%, more preferably at least about 25% and most preferably at least about 30% of height h. Distance d can extend 100% of height h, but preferably d extends less than about 98%, more preferably less than about 96%, and even more preferably, less than about 94% of height h.

Also shown in FIG. 1 is diameter Z, the width of infusion pod 12, diameter Y, the width of injection nozzle liquid opening 25, and diameter X, the width of injection nozzle bottom 27. While X, Y and Z are described as “diameters”, infusion pod 12 need not be round. In fact any geometric shape is acceptable. If infusion pod 12 is round then Z is the diameter of the top surface area of the pod, if the pod is square, then Z is the length of any edge of the square, if the pod is rectangular or elliptical then Z is the average of the major and minor dimensions. Those skilled in the art will understand how to calculate a “diameter” for the various appropriate geometries. Preferably Z is from about 2.0 cm to about 20 cm, more preferably from about 2.5 cm to about 15 cm and most preferably from about 3.0 cm to about 10 cm.

Depending on the geometry, X, Y and Z can be used to determine the three applicable surface areas. Y is preferably sized so that the surface area of the injection nozzle liquid opening is from about 2% to about 50% of the total surface area of liquid distribution member, as calculated with Z. Diameter X can be 0 cm, and it is preferably less than or approximately equal to Y. However, there is no technical reason that X cannot be larger than Y.

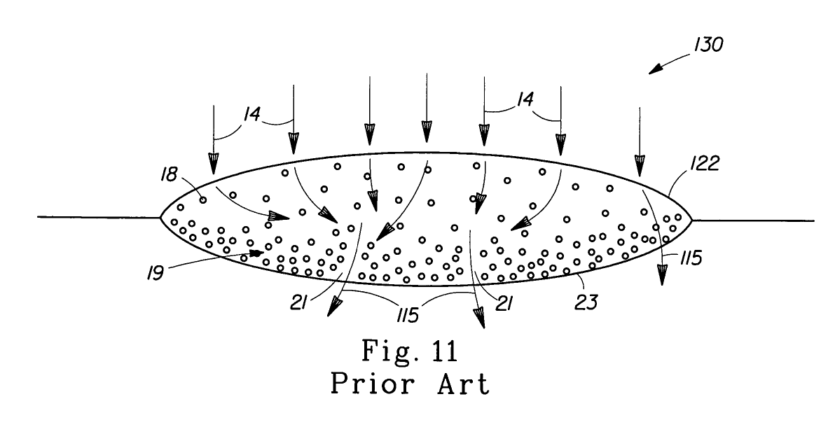

Returning now to high momentum fluid 16, it is understood that the momentum of a fluid is the product of the fluid's velocity and it's mass. And it is truly the fluid's momentum that fluidizes the liquid dispersible materials and prevents packing and caking of these materials that results in clogging of the bottom filter, see for example FIG. 11. Since fluidization of the liquid dispersible materials provides the desired benefit, it is preferred that the liquid enters the interior chamber at a relatively high momentum. Those skilled in the art will appreciate that “high” momentum is a relative term and will vary with the size and design of the pod. But it is equally understood that a high linear fluid velocity, with a very small mass flow rate may not be sufficient to fluidize the liquid dispersible materials within the pod. Likewise, a high mass flow rate and very low linear velocity may not sufficiently fluidize the liquid dispersible materials. Thus, the momentum of the fluid entering the interior chamber must be considered when designing the size of the infusion ports, and the number of ports. Those skilled in the art will be able to determine the appropriate momentum based on the desired flow rate of liquid through the infusion pod. In general, however, it is preferred that the infusion port be small enough that water will flow through it with a linear velocity of at least about 25 cm/second under a pressure of about 1.5 atmospheres or more.

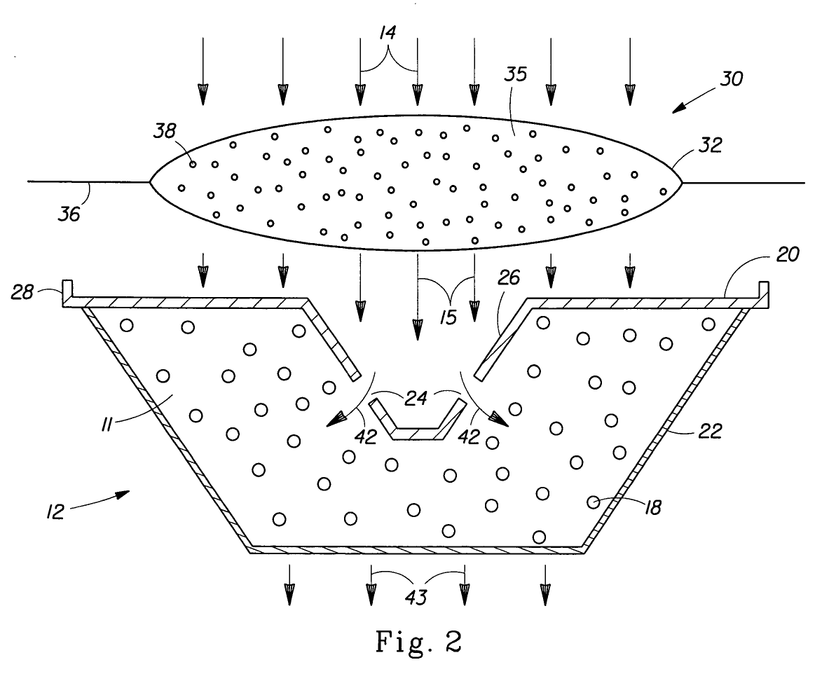

Turning now to FIG. 2 which shows the infusion pod 12 of FIG. 1 further comprising an extraction pod 30 situated above infusion pod 12 with respect to the flow of fresh liquid 14 through the two pods. Extraction pod 30 comprises a second filter member 32 which is sealed along filter edges 36 defining a second interior chamber, or extraction chamber 35. Extraction chamber 35 comprises an extractable material 38.

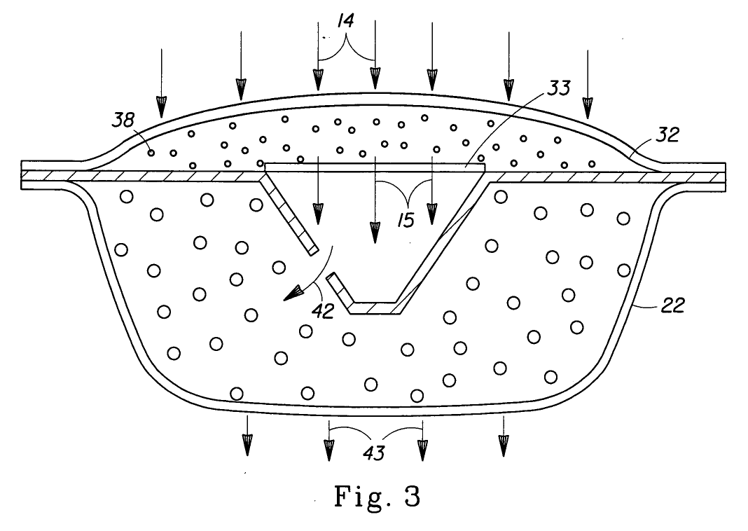

As can be seen, fresh liquid 14 flows through extraction pod 30 and exits as extracted liquid 15, which is collected on fluid distribution member 20. Extracted liquid 15 flows into injection nozzle 26 and is fed into infusion ports 24 as high momentum extracted liquid 42. After fluidizing and contacting liquid dispersible material 18 within first interior chamber 11, the liquid exits filter member 22 as post extraction and post infusion liquid 43. FIG. 3 illustrates a variation of the dual pod design of FIG. 1 wherein the second filter member 32 is sealed to the fluid distribution member forming one pod that contains both an extractable material 38 and a liquid dispersible material 18. Note that injection nozzle filter member 33 has been added to insure that extractable material 38 does not fill and clog injection nozzle 26. Note also, that only one infusion port 24 is shown in this embodiment. As discussed above, the number and size of infusion ports can be determined by those skilled in the art.

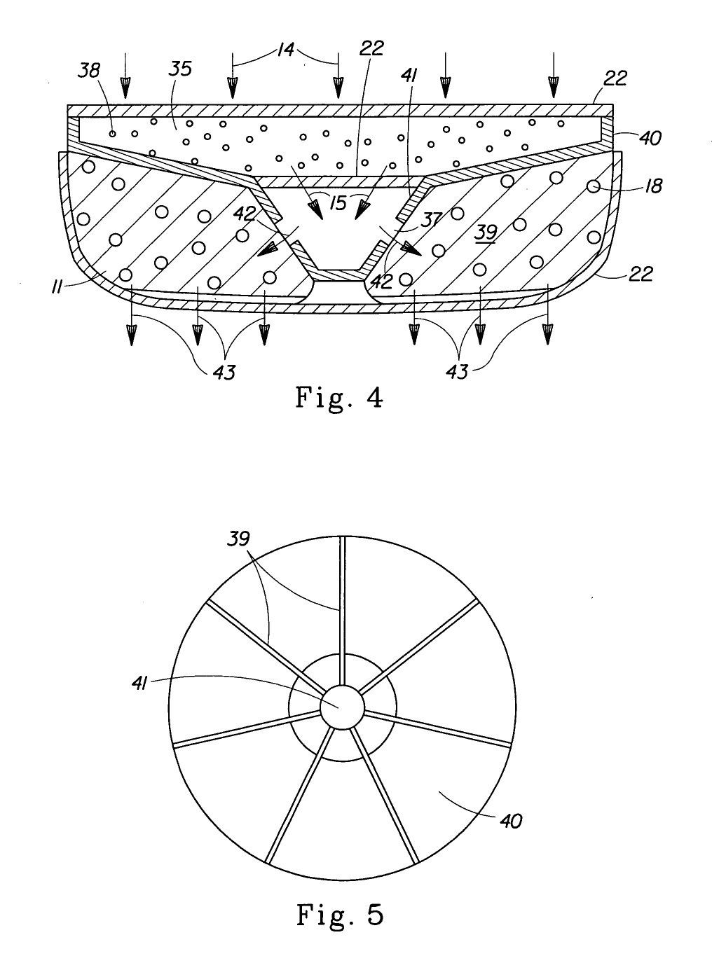

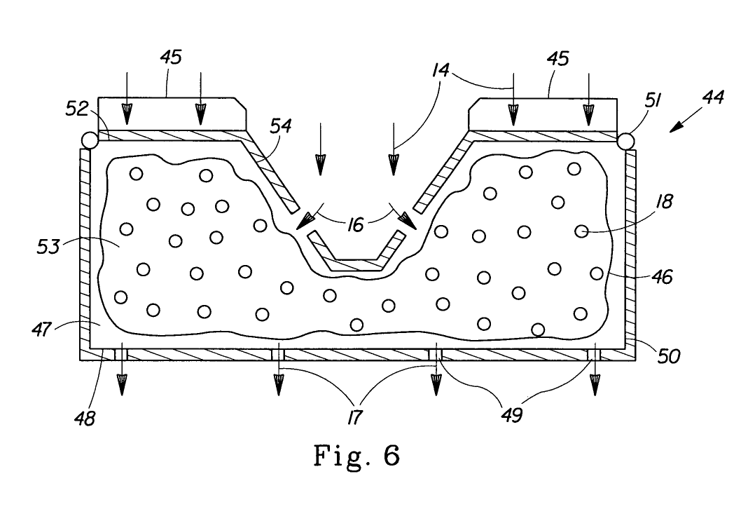

FIG. 4 shows yet another variation of the dual pod design wherein top filter member 31 is substantially adjacent and below the top plane TP. This configuration is made possible because fluid distribution member 40 slopes downward toward injection nozzle 41. As such, extractable material 38 is contained within the sloping portion of fluid distribution member 40. Once again, injection nozzle filter 33 is added to protect injection nozzle 41 and infusion ports 37 from being clogged with extractable material 38. Supporting baffles 39 are shown in FIG. 4 and FIG. 5. Supporting baffles 39 extend downward from fluid distribution member 40 to support and expand filter 22. These optional baffles can conform to filter 22 or can take a different shape depending on the desires of the pod designer. Likewise, as shown in FIG. 6 as supporting protrusions 45, supports can extend up from the fluid distribution member. Supporting protrusions 45 can be ribs, dimples, inverted channels, or another support structure, and are typically used to support an extraction pod above the infusion pod.

FIG. 6 illustrates yet another embodiment of the present invention wherein liquid infusion pod 44 comprises fluid distribution member 52 situated in a top plane TP. A liquid permeable first filter member is shown as infusion pod side walls 50, infusion pod bottom wall 48 and outlet ports 49. The first filter member is releaseably attached to fluid distribution member 52 at seal 51, forming a first interior chamber 47. Within first interior chamber 47 is a self contained, pre-dosed filter pod 46 having a second interior chamber 53 that comprises a liquid dispersible material 18. Fluid distribution member 52 comprises at least one injection nozzle 54 protruding downward from top plane TP into first interior chamber 47 without piercing the pre-dosed filter pod 46. Injection nozzle 54 has at least one infusion port 55 that directs high momentum fluid 16 into second interior chamber 53 in a direction that is not normal to the top plane. Post infusion liquid 17 exits infusion pod 44 via outlet ports 49.

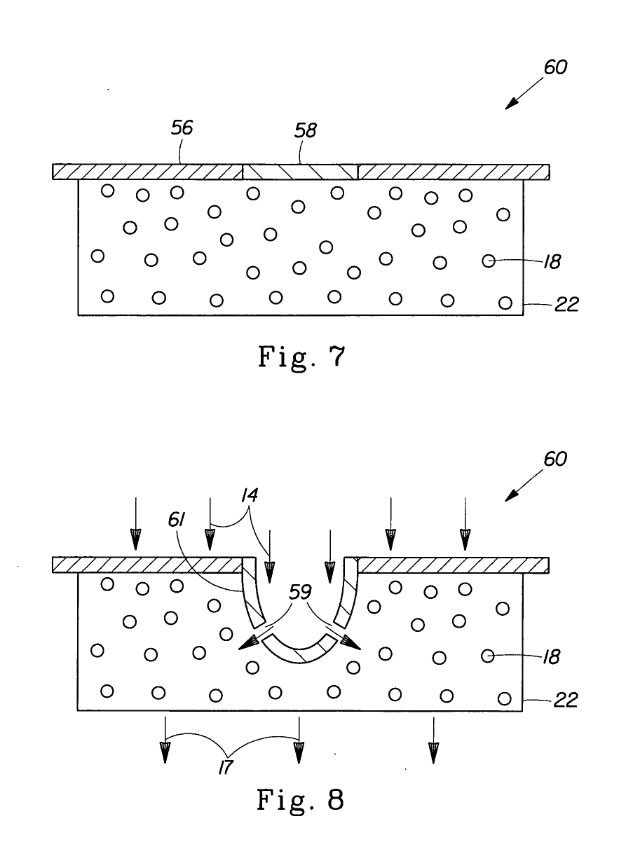

Turning now to FIGS. 7 and 8 which show yet another embodiment of the present invention. Specifically, infusion pod 60 comprises a fluid distribution member 56 and filter member 22 that combine to house liquid dispersible material 18. Fluid distribution member 56 has at least one deflectable injection nozzle 58 having a first position that is substantially flush with the top plane TP as shown in FIG. 7. Deflectable injection nozzle 58 has a second position shown as deflected injection nozzle 61 in FIG. 8, wherein it is protruding downward from top plane TP into first interior chamber 57. Deflected injection nozzle 61 has at least one infusion port 59 that is open when in the second position, and wherein infusion port 59 directs high momentum fluid 16 into first interior chamber 57 in a direction that is not normal to top plane TP. Deflectable injection nozzle 58 moves from its first position to the second position due to the force of liquid 14.

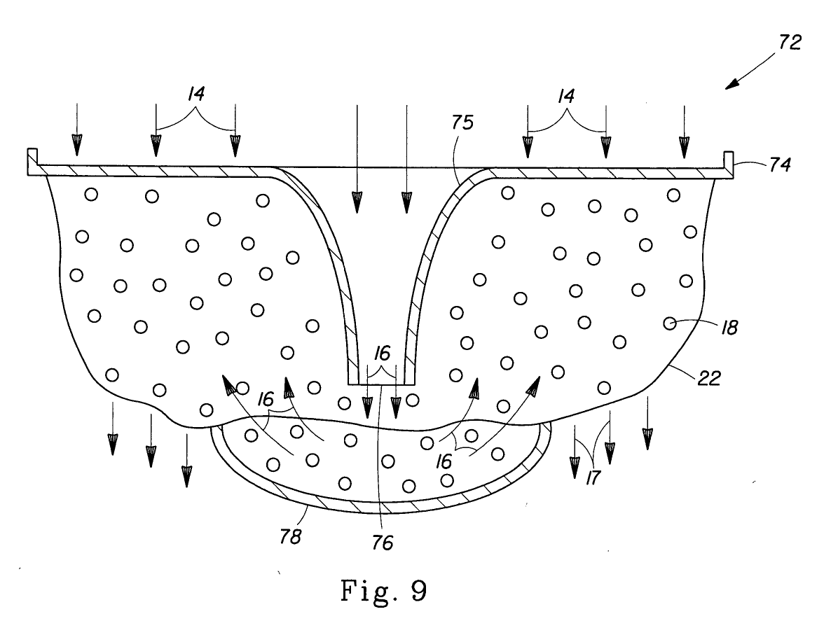

FIG. 9 illustrates a liquid infusion pod 72 comprising fluid distribution member 73 situated in top plane TP, and shown with optional end wall 74, and a liquid permeable first filter member 22. Filter member 22 is sealed to fluid distribution member 73 forming first interior chamber 11 that comprises liquid dispersible material 18. Fluid distribution member 73 comprises at least one injection nozzle 75 protruding downward from top plane TP into first interior chamber 11. Injection nozzle 75 has at least one infusion port 76 and at least one deflection plate 78. High momentum liquid 16 flows through infusion port 76 and is directed onto deflection plate 78 such that liquid 16 deflects off of deflection plate 78 into first interior chamber 11 in a direction that is not normal to the top plane TP. Post infusion liquid 17 ultimately exits pod 72 via filter member 22.

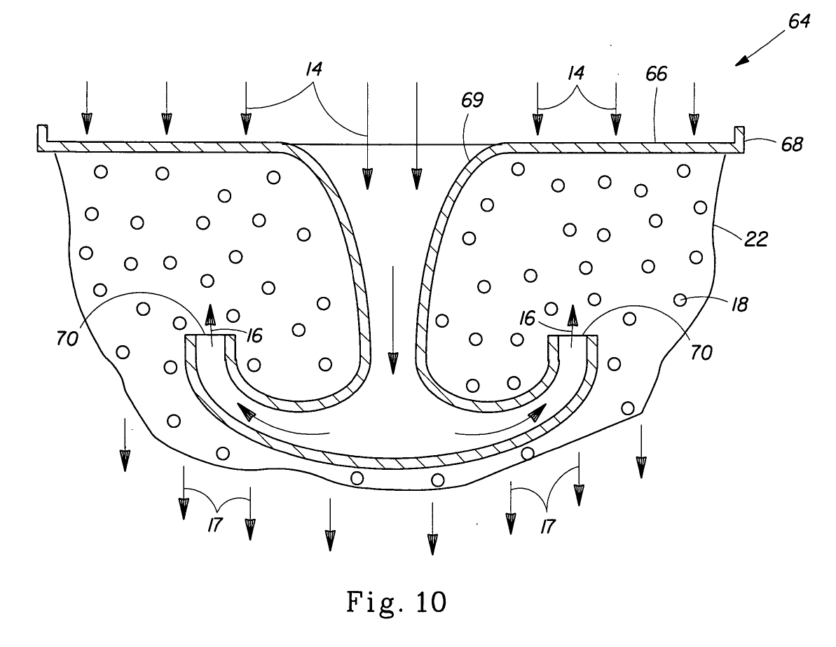

FIG. 10 illustrates yet another method of fluidizing a bed of liquid dispersible material 18. Specifically, infusion pod 64 comprises fluid distribution member 66, shown with optional end walls 68, having injection nozzle 69. Injection nozzle 69 comprises infusion ports 70 that redirect high momentum liquid 16 in a direction that is substantially normal to TP, but opposite the direction of flow for fresh liquid 14.

The forgoing embodiments of the present invention will be better understood with reference to the following description of the materials of construction, filter media, liquid dispersible materials, methods of using the present infusion pods and the example.

Material of Construction for Infusion Pods

In general, the infusion pods of the present invention can be made of any appropriate material. Materials for the filter members are discussed in greater detail below. It is understood, however, that the filter members defined herein must have some fluid permeability, while the fluid distribution member and the injection nozzle must be substantially liquid impermeable except for the infusion ports. By “substantially liquid impermeable” it is meant that at least about 90%, preferably at least about 95%, more preferably at least about 98%, by weight, of the liquid fed onto the liquid distribution member flows through the infusion ports into the first interior chamber.

The various parts the infusion pods can be comprised of rigid, semi-rigid, or non-rigid materials, including combinations thereof. The various parts of the present infusion pods may change their shape and/or rigidity, depending on the material selected and the given stage within the brewing process, see, for example, the injection nozzle 61 in FIGS. 7 and 8. Plastics, rubber, glass, treated paper, metals, semi rigid and rigid foams and the like are all suitable for use when making the pods of the present invention.

Filter Media

Filter members play a role in the design and functionality of the present infusion pods and may be manufactured from any material that provides the necessary liquid permeability and desired residence time while simultaneously providing both shape and fines retention, as explained further herein below. For example, filter media acceptable for use herein can be constructed from a variety of materials including, but not limited to, plastic, foil, non-woven polyester, polypropylene, polyethylene, paper materials, and combinations thereof as described in US Patent Application Publication No. 2005/0166763A1. In one embodiment, the filter media comprises a cellulose-based material, synthetic non-woven material or any other thermoplastic material. Examples of such material include, but are not limited to, spun-bonded or melt-blown non-woven polypropylene, spun-bonded or melt-blown polyester, spun-bonded nylon web, spun-bonded or melt-blown polyethylene, and combinations thereof. While the filter media may have any permeability, in one embodiment, the desired permeability of the filter media may be less than about 250 cfm/ft, in one embodiment from about 30 cfm/ft² to about 150 cm/ft², in another embodiment from about 30 cfm/ft² to about 125 cfm/ft², and in yet another embodiment from about 45 cfm/ft² to about 75 cfm/ft², as measured by the Analytical Method herein.

As described previously, the filter media may function in several ways. For example, the non-woven filter media can aid in both shape and fines retention, as well as improve brewing performance by providing a desired residence time to help ensure proper dissolution.

More specifically, the filter media may be selected to aid in shape retention during distribution. As previously discussed, many types of filter material may be flimsy, and therefore, can be susceptible to damage or destruction during shipment and distribution as the pods may be exposed to significant movement during such processes. Thickening the filter material can provide the added strength and rigidity needed to allow the infusion pods to retain their designed shape. More particularly, by, for example, layering, heat setting and/or pleating the non-woven filter media, and specifically the polyester-based materials, such materials may develop sufficient strength and rigidity to retain their designed shape. This in turn may help prevent damage to the pod during distribution, as well as help ensure a proper fit between the infusion pod and the brewing appliance. Specifically, the filter media may be capable of retaining its shape when numerous pods are stacked upon one another during packaging, as well as throughout the distribution process as the pods may be jostled about inside their packaging. By way of example and not limitation, one or more layers of filter material may be laminated together to make the final filter media. More specifically, three 0.5 oz/yd² layers of filter material, such as, for example, spun-bonded polyethylene or polyester, and one 0.53 oz/yd² layer of filter material, which again may be spun-bonded polyethylene or polyester, may be combined via a calendaring operation which laminates the four layers into a single layer having a permeability of about 300 cfm/ft². It will be understood by one skilled in the art that the permeability and number of layers of filter material may be varied as needed to achieve the desired shape retention qualities.

While the previous description encompasses one embodiment of a filter material providing the desired shape retention characteristics, such filter material may not, by itself, provide the additional desired characteristics as described herein below.

As mentioned, the filter media may be selected to aid in the retention of fines of the liquid dispersible material during distribution. Because it is not desirable to have fines of the liquid dispersible material sifting through the filter material during distribution, the filter material may be altered as described herein below to reduce, or even eliminate, this unwanted sifting during the distribution process.

Moreover, the filter media may improve brewing performance. For example, by altering the permeability of the filter media, as described below, the extracted liquid can be effectively redirected within the pod during the brewing process. This redirection of the extracted liquid may help ensure adequate contact (e.g. “residence time”) between the extract and a soluble or non-soluble component, such as a creamer, thus ensuring full dissolution of the creamer. While any degree of dissolution of the liquid dispersible material may be desired for a particular application, in one embodiment, from about 5 oz. to about 9 oz, in one embodiment about 7 oz., of fresh liquid can be used to obtain at least about 50% dissolution, in one embodiment at least about 75% dissolution, in another embodiment at least about 80% dissolution, in yet another embodiment at least about 85% dissolution, and in still another embodiment at least about 90% dissolution of the liquid dispersible material contained within the infusion pod. Moreover, in one embodiment, the previously described dissolutions may occur in less than about 180 seconds, in one embodiment less than about 120 seconds, in another embodiment less than about 90 seconds, and in yet another embodiment less than about 60 seconds, after the fresh liquid enters the infusion pod.

However, as previously discussed, one issue with many filter materials is that they often do not provide all of the previously described desired characteristics. Generally, filter materials may be capable of providing either the desired fines retention or the desired residence time, but not both. For example, in some instances, a permeability of greater than about 250 cfm/ft² may be too great to prevent the sifting of fines through the filter material and/or the exiting of the post infusion liquid from the pod before the desired dissolution has occurred.

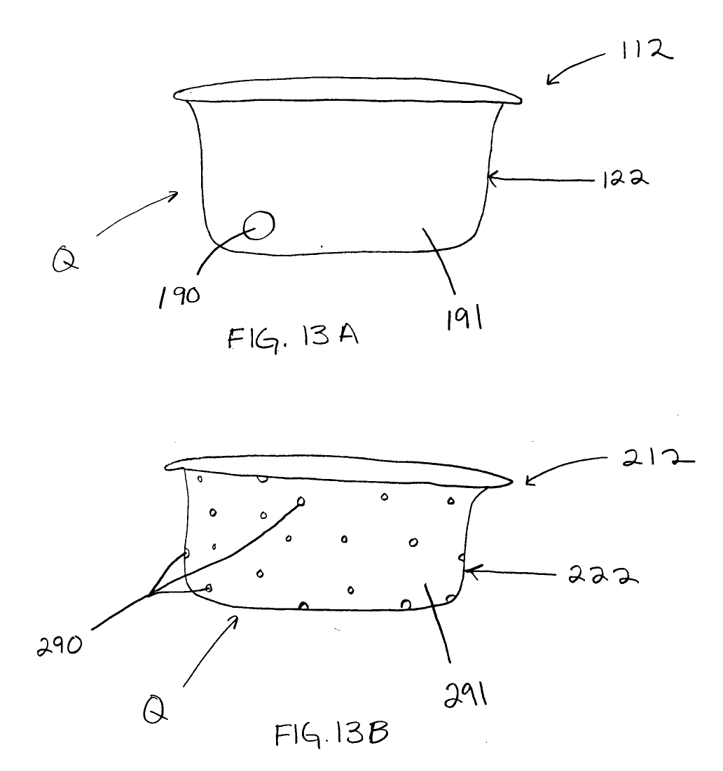

To address this outage, the present inventors have surprisingly and unexpectedly discovered that even though as the permeability of the filter material increases, both fines retention and residence time tends to decrease, the permeability of the filter material may be altered in several ways to achieve optimum fines retention, as well as the residence time needed to ensure the desired dissolution, while still providing enough permeability to allow the post infusion liquid to exit the pod after the desired degree dissolution has occurred. The filter material, and more specifically, the first filter member, may comprise at least one first region 190 and at least one second region 191 (as shown in FIG. 13A) wherein the permeability of the first region differs from the permeability of the second region such that the overall permeability of the filter media may be less than about 250 cfm/ft², in one embodiment from about 30 cfm/ft² to about 150 cfm/ft², in another embodiment from about 30 cfm/ft² to about 125 cfm/ft², and in still another embodiment from about 45 cfm/ft² to about 75 cfm/ft², as determined by the Analytical Method disclosed herein.

In one embodiment, the permeability of the first region 190 may be decreased relative to the permeability of the second region 191. Providing regions of differing permeability may be desired to create an optimum filter material for a particular product when such a material is not readily available. For example, altered regions may be used to create a filter material that provides shape and fines retention, as well as the desired residence time, while simultaneously allowing the post infusion liquid to easily exit the pod once dissolution is complete. Such regions of differing permeability may be created by, for example, embossing, laminating and/or coating at least a portion of the filter material, as described herein below. While the following focuses on embossing, laminating and coating, other methods of altering the filter media are acceptable for use herein.

Filter material may be embossed by way of heat or ultrasonics to provide more controlled permeability that provides the desired fines retention and residence time needed for proper brewing. More specifically, during embossing, the first region of the filter media can be compressed, heat sealed or bonded such that the first region may have decreased permeability relative to the permeability of the second region that has not been embossed. As previously mentioned, embossing may be desired to increase the effectiveness of the filter media in controlling the flow pattern of the product, thereby helping to ensure optimum dissolution of the liquid-dispersible materials disposed therein. Moreover, embossing can help reduce the overall permeability of the filter media, thereby aiding in fines retention during distribution. Also, embossing may also help to ensure that a multiple layered filter structure is sufficiently bonded together, which, in turn, may help ensure that the material can be processed effectively on the finished product manufacturing equipment.

Additionally, laminates or other substrates may be applied to the filter media to create a first region having a different permeability than the second region. Laminates such as, foils of plastics, may be applied to at least a portion of the inside, outside or both, of the filter media to create the first region and a second region having different permeability. In one embodiment, the permeability of the first region may be decreased relative to the permeability of the second region. Application of the laminates generally occurs through thermal bonding, ultrasonic bonding, chemical bonding, adhesive bonding, solvent bonding, mechanical bonding or extrusion bonding processes, though other methods known to those skilled in the art are acceptable for use herein. Similar to embossing, laminates may be used to make a highly porous and liquid permeable filter material less porous and less liquid permeable. Using laminates or other like substrates in this manner may be desired as another way by which to increase the effectiveness of the filter media in controlling the flow pattern of the product, thereby helping to ensure optimum dissolution of the liquid-dispersible materials disposed therein.

Also, a high-permeability filter media having a permeability of greater than about 250 cfm/ft² can be coated with a water soluble material such that the permeability of the filter media may be decreased to less than about 250 cfm/ft², in one embodiment from about 30 cfm/ft² to about 150 cfm/ft², in another embodiment from about 30 cfm/ft² to about 125 cfm/ft², and in still another embodiment from about 45 cfm/ft² to about 75 cfm/ft². In use, as the water soluble material dissolves, the permeability of the filter material can be substantially restored over time back to greater than about 250 cfm/ft during use (e.g. brewing). Some examples of water soluble materials acceptable for use herein include, but are not limited to, ethyl vinyl alcohol (EVOH) and starch coatings. Those skilled in the art will understand that other water soluble materials are also acceptable for use herein. The water soluble material may be applied to the inside, outside or both, of the filter media through lamination, thermal bonding, ultrasonic bonding, chemical bonding, adhesive bonding, solvent bonding, mechanical bonding, spray coating, extrusion coating, immersion processes, or other like processes, to produce a first region 190 and a second region 191 having differing permeability. The coated filter media may then be used to construct an infusion pod as described herein. By coating the filter media in this manner, the liquid dispersible materials within the infusion pods can be contained during shipping and transporting yet available for dissolution during brewing. Generally, the water soluble material may begin to dissolve upon contact with liquid, though the thickness and/or type of water soluble material used can influence how quickly the water soluble material dissolves. It will be understood that the type and thickness of the soluble material may be chosen based on the dissolution properties of the liquid dispersible material contained within the pod.

Additionally, those skilled in the art will understand that other methods of altering the filter media may be acceptable for use herein to achieve the desired results. For instance, additional layers of filter material may be added to four layers described previously to obtain the desired permeability of less than about 250 cfm/ft². Likewise, various dimensions of the non-woven filter material, such as, for example, strand width, could be altered such that the desired qualities described herein may be achieved with fewer layers of material.

The first filter member 122 (in FIG. 13A) or 222 (in FIG. 13B) may be of any size needed to construct the infusion pod 112 and may have a surface area (O). Each of first region 190 (as shown in FIG. 13A) or 290 (as shown in FIG. 13B) and second region 191 (as shown in FIG. 13A) or 291 (as shown in FIG. 13B) described herein above may account for from about 0.1% to about 99.9%, in one embodiment from about 5% to about 85%, in another embodiment from about 5% to about 50%, in still another embodiment from about 5% to about 40%, and in yet another embodiment from about 10% to about 35%, of surface area Q of first filter member 122. More specifically, each of the first region or second region may account for a small portion of the surface area of the first filter member, substantially all of the surface area of the first filter member, or any portion of the surface area of the first filter member, used to construct the infusion pod. Moreover, there may be one first region 190 comprising embossing, laminating or coating of first filter member 122 of infusion pod 112 (as shown in FIG. 13A) or there may be more than one first region 290 of embossing, laminating or coating of first filter member 222 of infusion pod 212 (as shown in FIG. 13B). Furthermore, while the first regions illustrated in FIGS. 13A and 13B are substantially circular, it will be understood that the first regions may take any shape or configuration including, but not limited to, triangles, squares, ovals, crosses, letters, numbers and the like, as well as combinations thereof. Moreover, the first regions may be distributed in a uniform, repetitive pattern across the surface area of the filter member or, alternately, may be distributed randomly.

Liquid Dispersible Materials

The infusion pods of this invention comprise a liquid dispersible material. Below are examples of these materials that are suitable for use in the present invention. Preferably, the liquid dispersible material is selected from the group consisting of dissolvable materials, liquid extractable materials, non-dissolvable materials and mixtures thereof. Further, the liquid dispersible material can be selected from the group consisting of solids, powders, granules, and mixtures thereof. Preferably the liquid dispersible material is selected from the group consisting of particles whose sizes are, in one embodiment from about 10 μm to about 1 cm, in one embodiment from about 100 μm to about 1 cm, and in another embodiment from about 200 nm to about 1000 nm, in diameter.

As used herein, “liquid” is intended to take on its broadest possible meaning. Water is the preferred liquid for use with the infusion pods of this invention, but milk, fruit juice and the like are acceptable. The liquid is preferably used at elevated temperatures, that is, greater than about 30° C., preferably greater than about 40° C. and more preferably greater than about 60° C. It is well known that liquids at elevated temperatures aid in extraction and dispersion processes as defined herein.

In certain embodiments of the present invention, there is provided a second filter member that is sealed to the fluid distribution member on the side opposite the first filter member defining a second interior chamber, which comprises a liquid extractable material. The liquid extractable material, for example, coffee grounds, tea leaves and the like, preferably comprises less than about 2%, more preferably less than about 1.5%, and even more preferably less than about 1.0%, by weight, of added materials selected from the group consisting of oils, fats, proteins and mixtures of these. It is understood that certain extractable materials, for example, coffee grounds, contain oils, but theses are not “added” oils as defined herein.

1) Fat/Oil

As used herein, the terms “fat” and “oils” are used interchangeably. Suitable oils for use in the compositions of the present invention include any edible oil. The oils can be comprised of completely saturated, partially saturated, unsaturated fatty acids or mixtures thereof. Preferred oils for use in the liquid dispersible materials herein include soybean oil, canola (low erucic acid) oil, corn oil, cottonseed oil, peanut oil, safflower oil, sunflower oil, rapeseed oil, sesame oil, olive oil, coconut oil, palm kernel oil, palm oil, tallow, butter, lard, fish oil, and mixtures thereof.

2) Protein

Suitable protein sources include plant, dairy, and other animal protein sources. Preferred proteins for preparing the liquid dispersible materials of the present invention include egg and milk proteins, plant proteins (including oilseed proteins obtained from cotton, palm, rape, safflower, cocoa, sunflower, sesame, soy, peanut, and the like), microbial proteins such as yeast proteins, so-called “single cell” proteins, and mixtures thereof. Preferred proteins also include dairy whey protein (including sweet dairy whey protein), and non-dairy proteins such as bovine serum albumin, egg white albumin, and vegetable whey proteins (i.e., non-dairy whey protein) such as soy protein. Especially preferred proteins for use in the present invention include whey proteins, such as β-lactoglobulins and α-lactalbumins; bovine serum albumins; egg proteins, such as ovalbumins; and, soy proteins, such as glycinin and conglycinin. Combinations of these especially preferred proteins are also acceptable for use in the present invention.

Preferred sources for protein particles herein include, but are not limited to, partially insoluble, partially denatured protein compositions such as Simplesse 100®, available from the CP-Kelco Company of San Diego, Calif. and DAIRY-LO® from The Pfizer Company of New York, N.Y., both of which are whey proteins. Examples of these preferred protein sources are disclosed in U.S. Pat. No. 4,734,287 to Singer et al., issued Mar. 29, 1988; and U.S. Pat. No. 4,961,953 to Singer et al., issued Jun. 16, 1989, both of which are herein incorporated by reference. Especially preferred protein particle sources for use in the compositions of the present invention, and methods for making such protein particles sources, are disclosed in co-pending U.S. patent application Ser. No. 09/885,693, filed Jun. 22, 2001 to Francisco V. Villagran et al., which is herein incorporated by reference.

3) Carbohydrate Component

Suitable carbohydrates include, but are not limited to, LITA®, a mixture of Zein protein and gum arabic. See for example, U.S. Pat. No. 4,911,946 to Singer et al., issued Mar. 27, 1990; and U.S. Pat. No. 5,153,020 to Singer et al., issued Oct. 6, 1992, both of which are herein incorporated by reference. Other suitable carbohydrates include starches, gums and/or cellulose, as well as mixtures thereof. The starches are typically modified by cross-linking to prevent excessive swelling of the starch granules using methods well known to those skilled in the art. Additional suitable carbohydrates include calcium alginate, cross-linked alginates, dextran, gellan gum, curdlan, konjac mannan, chitin, schizophyllan and chitosan.

Preferred carbohydrate microparticles of the present invention are substantially non-aggregated. Aggregate blocking agents, for example, lecithin and xanthan gum, can be added to the carbohydrate microparticles to stabilize the particles. See U.S. Pat. No. 4,734,287 to Singer et al., issued Mar. 29, 1988, which is herein incorporated by reference.

Suitable carbohydrates for use in the liquid dispersible materials of the present invention may additionally include microcrystalline cellulose particles. The exact amount of the microcrystalline cellulose component, if one is included, is dependent on the nature of the specific beverage formulation desired and the remaining ingredients selected. Microcrystalline cellulose, which is also known in the art as “cellulose gel,” is a non-fibrous form of cellulose that is prepared by partially depolymerizing cellulose obtained as a pulp from fibrous plant material with dilute mineral acid solutions. See U.S. Pat. No. 3,023,104, issued Feb. 27, 1962; U.S. Pat. No. 2,978,446; and U.S. Pat. No. 3,141,875, each of which is herein incorporated by reference, that disclose suitable methods of preparing the microcrystalline cellulose used herein. Suitable commercially available microcrystalline cellulose source include EMCOCEL®, from the Edward Mendell Co., Inc. and Avicel®, from FMC Corporation.

Suitable, microcrystalline cellulose sources may also be produced through a microbial fermentation process. Commercially available microcrystalline cellulose produced by a fermentation process includes PrimaCEL™, available from The Nutrasweet Kelco Company of Chicago, Ill.

4) Emulsifier

Emulsifiers of the type used herein help to disperse fat and oil in the food and beverage products comprising the liquid dispersible materials of the present invention. Any food grade emulsifier suitable for inclusion in edible products can be used. Examples of suitable emulsifiers include mono and diglycerides of long chain fatty acids, preferably saturated fatty acids, and most preferably, stearic and palmitic acid mono and diglycerides. Propylene glycol esters are also useful in these edible mixes. Lecithin is an especially preferred emulsifier in the liquid dispersible materials of the present invention. The emulsifier can be any food compatible emulsifier such as mono and diglycerides, lecithin, sucrose monoesters, polyglycerol esters, sorbitan esters, polyethoxylated glycerols and mixtures thereof.

Other suitable emulsifiers include lactylated mono and diglycerides, propylene glycol monoesters, polyglycerol esters, diacetylated tartaric acid esters of mono- and di-glycerides, citric acid esters of monoglycerides, stearoyl-2-lactylates, polysorbates, succinylated monoglycerides, acetylated monoglycerides, ethoxylated monoglycerides, lecithin, sucrose monoester, and mixtures thereof. Suitable emulsifiers include Dimodan® 0, Dimodan® PV, and Panodan® FDP, manufactured by the Danisco Food Ingredients Company. The emulsifiers may optionally be utilized with a co-emulsifier. Depending on the particular formulation chosen, suitable co-emulsifiers may be chosen from any food compatible co-emulsifier or emulsifier. Particularly preferred emulsifier/co-emulsifier systems include Dimodan® 0, Dimodan® PV, and Panodan® FDP.

A more detailed discussion of these preferred emulsifiers, including a description of the analytical methods used to test dispersibility can be found in co-pending U.S. patent Ser. No. 09/965,113, filed Sep. 26, 2001 to Lin et al., herein incorporated by reference.

5) Bulking Agents

Bulking agents are defined herein as those ingredients that do not substantially contribute to the overall mouthfeel, texture, or taste of the powdered and liquid, dairy and non-dairy liquid dispersible materials of the present invention. The primary purpose of bulking agents is to control the overall concentration of solids in solution.

Suitable bulking agents are selected from the group consisting of corn syrup solids, maltodextrin and various dextrose equivalents, starches, and mixtures thereof. Corn syrup solids are particularly preferred bulking agents because of their cost and processability.

6) Milk Solids

The liquid dispersible materials of the present invention may optionally comprise non-microparticulated dairy proteins (e.g., milk solids). These milk solids can be prepared by drying milk to produce a mixture of the proteins, minerals, whey and other components of milk in a dry form. The milk solids may include butterfat solids and cream powder, and preferably include low-fat dry milk and non-fat milk solids. Especially preferred milk solids are those milk solids derived from milk that has had the fat removed.

Suitable milk solids for use in the present invention can be derived from a variety of commercial sources. Dry mixes typically used to prepare ice cream, milk-shakes, and frozen desserts may also be included in the liquid dispersible materials herein. These dry mixes provide an especially creamy, rich mouthfeel to the liquid dispersible material when the liquid dispersible materials of the present invention are mixed with water or other beverage or food product.

7) Soluble Beverage Components

The liquid dispersible materials of the present invention may optionally comprise soluble beverage components. Suitable soluble beverage components are readily available to, and can be easily chosen by, one having ordinary skill in the art. Soluble beverage components include, but are not limited to, coffee, tea, juice, and mixtures thereof. The soluble beverage components may be in liquid, solid concentrate, powder, extract, or emulsion form.

The preferred soluble beverage component for use in a given flavored beverage product containing the liquid dispersible materials of the present invention is determined by the particular application of the liquid dispersible material product. For example, if the final application is intended to be a coffee beverage, the soluble beverage component is, generally, coffee. For a tea or juice beverage product, the soluble beverage component is generally, tea or juice, respectively.

Suitable soluble coffee components, for use in a given flavored beverage product containing the liquid dispersible materials of the present invention, can be prepared by any convenient process. A variety of such processes are known to those skilled in the art. Typically, soluble coffee is prepared by roasting and grinding a blend of coffee beans, extracting the roast and ground coffee with water to form an aqueous coffee extract, and drying the extract to form instant coffee. Soluble coffee useful in the present invention is typically obtained by conventional spray drying processes.

Representative spray drying processes that can provide suitable soluble coffee are disclosed in, for example, pages 382-513 of Sivetz & Foote, COFFEE PROCESSING TECHNOLOGY, Vol. I (Avi Publishing Co. 1963); U.S. Pat. No. 2,771,343 (Chase et al), issued Nov. 20, 1956; U.S. Pat. No. 2,750,998 (Moore), issued Jun. 19, 1956; and U.S. Pat. No. 2,469,553 (Hall), issued May 10, 1949, each of which is incorporated herein by reference. Other suitable processes for providing instant coffee for use in the present invention are disclosed in, for example, U.S. Pat. No. 3,436,227 (Bergeron et al), issued Apr. 1, 1969; U.S. Pat. No. 3,493,388 (Hair), issued Feb. 3, 1970; U.S. Pat. No. 3,615,669 (Hair et al), issued Oct. 26, 1971; U.S. Pat. No. 3,620,756, (Strobel et al), issued Nov. 16, 1971; U.S. Pat. No. 3,652,293 (Lombana et al), issued Mar. 28, 1972, each of which is incorporated herein by reference.

In addition to spray dried instant coffee powders, instant coffee useful in the present invention can include freeze-dried coffee. The instant coffee can be prepared from any single variety of coffees or a blend of different varieties. The instant coffee can be decaffeinated or caffeinated and can be processed to reflect a unique flavor characteristic such as espresso, French roast, or the like.

8) Buffers

The liquid dispersible materials of the present invention may optionally comprise a buffering system. Suitable buffering systems for use herein are capable of maintaining the pH value of the finished, ready to consume beverage product including the present liquid dispersible materials in the range of from about 5.5 to about 7.2. Preferred buffering systems comprise stabilizing salts capable of improving the colloidal solubility of proteins and simultaneously maintaining the pH value of a beverage in the range of from about 5.5 to 7.2, in order to achieve optimum stability and flavor.

Preferred stabilizing salts include the disodium and/or dipotassium salts of citric acid and/or phosphoric acid. The use of phosphate salts is particularly desirable when the water used for the preparation of the beverage is high in calcium or magnesium.

Suitable buffering systems for use in the liquid dispersible materials of the present invention may also be combined with flavor profile mimicking, matching, manipulation and/or adjustment systems comprising various taste contributing acids and bases. Especially preferred flavor profile mimicking, matching, manipulation and/or adjustment systems for use in the present invention are disclosed in co-pending U.S. patent application Ser. No. 10/074,851, filed Feb. 13, 2002 to Hardesty et al., which is incorporated herein by reference.

9) Thickeners

The liquid dispersible materials of the present invention may optionally comprise one or more thickening agents. As used herein, the term “thickening agent” includes natural and synthetic gums, and natural and chemically modified starches. It is preferred that the thickening agents of the present invention be comprised predominately of starches, and that no more than 20%, preferably no more than 10%, of the thickener be comprised of gums.

Suitable starches for use herein include, but are not limited to, pregelatinized starch (corn, wheat, tapioca), pregelatinized high amylose content starch, pregelatinized hydrolyzed starches (maltodextrins, corn syrup solids), chemically modified starches such as pregelatinized substituted starches (e.g., octenyl succinate modified starches such as N-Creamer®, N-Lite LP®, and TEXTRA®, manufactured by the National Starch Company), as well as mixtures of these starches. Suitable gums for use herein include locust bean gum, guar gum, gellan gum, xanthan gum, gum ghatti, modified gum ghatti, tragacanth gum, carrageenan, and/or anionic polymers derived from cellulose such as carboxymethylcellulose, sodium carboxymethylcellulose, as well as mixtures of these gums.

10) Foaming Agents

The liquid dispersible materials of the present invention may optionally comprise foaming agents and/or a foaming system for generating consumer preferred amounts of foam in a finished beverage product comprising the present liquid dispersible materials. Suitable foaming systems for use in the present invention include any compound, or combination of compounds, capable of rendering a desired foam head, of a given height and density, in the finished beverage product. Preferred foaming systems for use herein comprise an acid ingredient and a carbonate and/or bicarbonate ingredient, that when allowed to react together generate foam.

As used herein, the term “acid ingredient” refers to an edible, water-soluble, organic or inorganic acid. Preferred acids include, but are not limited to, citric acid, malic acid, tartaric acid, fumaric acid, succinic acid, phosphoric acid, as well as mixtures of these acids. As used herein, the term “Carbonate” and “Bicarbonate” refer to an edible, water-soluble carbonate or bicarbonate salt that evolves carbon dioxide when it reacts with the acid ingredient. Preferred carbonate and bicarbonate salts include, but are not limited to, sodium bicarbonate, sodium carbonate, potassium bicarbonate, potassium bicarbonate, as well as any mixture thereof. Mixtures of sodium carbonate and sodium bicarbonate are especially preferred when used in combination with citric acid.

The foaming agents and/or foaming systems may optionally comprise one or more foam stabilizing ingredients. Suitable proteinaceous foam stabilizers include non-microparticulated egg white albumin (ovalbumin), whey protein, soy protein, soy protein isolate, corn protein isolate, as well as mixtures of these stabilizers. Non-microparticulated dried egg white albumin is particularly preferred because of its ability to form stable foams at relatively low concentrations.

11) Sweeteners

The liquid dispersible materials of the present invention may optionally comprise one or more sweeteners. Preferred sweeteners for use in the present invention include, but are not limited to, sugars and sugar alcohols such as sucrose, fructose, dextrose, maltose, lactose, high fructose corn syrup solids, invert sugar, sugar alcohols, including sorbitol, as well as mixtures of these sugars and sugar alcohols.

In embodiments of the present invention where it is preferable to deliver lower levels of solids per dosage, it is particularly preferred to use a higher intensity sweetener with the sugar or sugar alcohol. These higher intensity sweeteners include saccharin; cyclamates; acesulfame K; L-aspartyl-L-phenylalanine lower alkyl ester sweeteners (e.g., aspartame); L-aspartyl-D-alanine amides, disclosed in U.S. Pat. No. 4,411,925 to Brennan et al.; L-aspartyl-D-serine amides, disclosed in U.S. Pat. No. 4,399,163 to Brennan et al; L-aspartyl-L-1-hydroxymethylalkaneamide sweeteners, disclosed in U.S. Pat. No. 4,338,346 to Brand et al.; L-aspartyl-1-hydroxyethyalkaneamide sweeteners, disclosed in U.S. Pat. No. 4,423,029 to Rizzi; and L-aspartyl-D-phenylglycine ester and amide sweeteners, disclosed in European Patent Application 168,112 to J. M. Janusz, published Jan. 15, 1986. Mixtures of the high intensity sweeteners disclosed herein, as well as mixtures of the high intensity sweeteners and sugars and sugar alcohols, are equally suitable for use in the liquid dispersible materials of the present invention.

A particularly preferred sweetener system is a combination of sucrose with aspartame and acesulfame K. This mixture not only enhances sweetness, but also lowers the level of solids that is required in preparing the food and beverage products comprising the present liquid dispersible material.

12) Processing Aids

The liquid dispersible materials of the present invention may optionally comprise processing aids, including flow aids, anti-caking agents, dispersing aids, and the like. Preferred processing aides include, but are not limited to, flow aids such as silicon dioxide and silica aluminates. Starches, aside from the thickening agents, can also be included to keep the various ingredients from caking.

13) Flavorants

The liquid dispersible materials of the present invention may optionally comprise one or more flavorants used to deliver one or more specific flavor impacts. Preferred flavors of the type used herein are typically obtained from encapsulated and/or liquid flavorants. These flavorants can be natural or artificial in origin. Preferred flavors, or mixtures of flavor, include almond nut, amaretto, anisette, brandy, cappuccino, mint, cinnamon, cinnamon almond, creme de menthe, Grand Mariner, peppermint stick, pistachio, sambuca, apple, chamomile, cinnamon spice, creme, creme de menthe, vanilla, French vanilla, Irish creme, Kahlua, mint, peppermint, lemon, macadamia nut, orange, orange leaf, peach, strawberry, grape, raspberry, cherry, coffee, chocolate, cocoa, mocha and the like, and mixtures thereof. The liquid dispersible materials of the present invention may also comprise aroma enhancers such as acetaldehyde, herbs, spices, as well as mixtures thereof.

Methods of Using the Infusion Pods

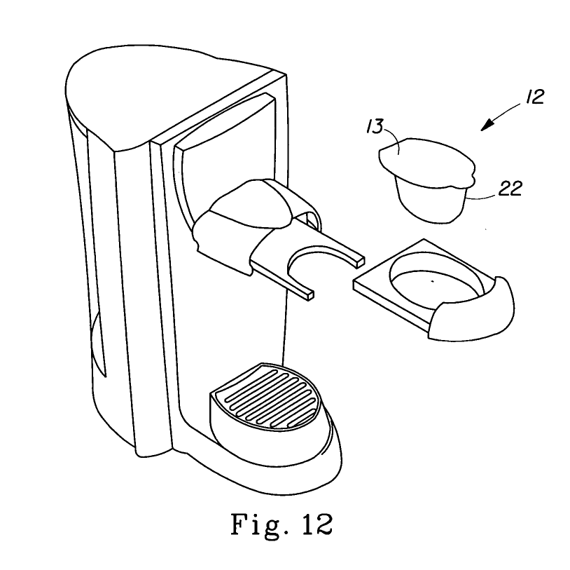

The use of the infusion pods of the present invention is best understood with reference to FIG. 12 which shows infusion brewer 200. Infusion pod 12 is shown with protective cover 13 which must be removed before infusion pod 12 can be used. Filter member 22 is shown below protective cover 13. Infusion pod 12 fits into receiving tray 210 which then slides into tray receptacle 214. Infusion liquid 215 is charged into liquid receptacle 216 and mug 212 is placed under tray receptacle 214. Infusion liquid 215, which is preferably water, is heated and pressurized within brewer 200 and then injected into infusion pod 12. The heated liquid is preferably pressurized to at least about 10 psig, more preferably at least about 15 psig, and even more preferably at least about 20 psig. The heated and pressurized liquid flows through infusion pod 12 as described in detail above, and a tasty infusion beverage flows out of filter member 22 into mug 212. Preferred beverage preparation times are less than about 120 seconds, more preferably less than about 90 seconds, more preferably less than about 75 seconds, more preferably less than 60 seconds.

### Analytical Method

1. Permeability:

Permeability measures how resistant the overall sample filter material is to air flow through a known flow area and may be determined using ASTM D737-96.

### EXAMPLES

### Example 1

A multi-layered polyethylene filter material, comprised of five layers, each layer having a permeability of approximately 1000 to 1500 cfm/ft², is placed in a point bonding/lamination device known to those skilled in the art and embossed to create at least one first region and at least one second region. The first regions have a decreased permeability relative to the second regions. The resulting filter material is removed from the point bonding/lamination equipment and the permeability is determined to be approximately 45 to 75 cfm/ft², as measured by the Analytical Method provided herein. The filter material is then used to construct the first filter member of an infusion pod, wherein the first regions account for about 45% of the area of the first filter member. In use, about 7 oz. of fresh liquid enters the infusion pod, resulting in dissolution of at least about 90% of a liquid dispersible material contained within in the pod in less than about 60 seconds.

### Example 2

A single layered polyethylene filter material having a permeability of about 500 cfm/ft² is placed in an ultrasonic device known to those skilled in the art and selected portions of the filter material are bonded together to create multiple first regions and multiple second regions, the first and second regions having differing permeability. The resulting filter material is removed from the ultrasonic device and the permeability is determined to be about 90 cfm/ft² to about 125 cfm/ft², as measured by the Analytical Method provided herein. The filter material is then used to construct the first filter member of an infusion pod, wherein the first regions account for about 20% of the area of the first filter member. In use, about 9 oz. of fresh liquid enters the infusion pod, resulting in dissolution of at least about 75% of a liquid dispersible material contained within in the pod in less than about 120 seconds.

### Example 3

A multi-layered polyethylene/polyester filter material, comprised of 3 layers, each layer having a permeability of approximately 1000 to 1500 cfm/ft² is spray coated with a starch and water solution to create a first region of decreased permeability. The water is evaporated off using techniques known to those skilled in the art and the permeability of the filter material is determined to be about 100 to 150 cfm/ft², as measured by the Analytical Method provided herein. The filter material is then used to construct a first filter member of an infusion pod, wherein the coated first region accounts for about 96% of the area of the first filter member. In use, as the fresh liquid from the brewing device contacts the first region comprising the water-soluble starch coating, the coating dissolves, thereby increasing the permeability of the first filter member back to about 1000 to 1500 cfm/ft². This gradual increase in permeability allows the fresh liquid to enter and remain in the pod for a desired residence time and the post infusion liquid to exit the pod. In use, about 5 oz. of fresh liquid enters the infusion pod, resulting in dissolution of at least about 50% of a liquid dispersible material contained within in the pod in less than about 180 seconds.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1) A liquid infusion pod comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, the first filter member comprising at least one first region and at least one second region wherein the permeability of the first region is different from the permeability of the second region.

2) The liquid infusion pod of claim 1 wherein the first region is created by a method selected from the group consisting of embossing the first filter member, laminating the first filter member, coating the first filter member and combinations thereof.

3) The liquid infusion pod of claim 2 wherein the first filter member has an area and the first region accounts for from about 0.1% to about 99.9% of the area of the first filter member.

4) The liquid infusion pod of claim 2 wherein the first filter member comprises a material selected from the group consisting of spun-bonded or melt-blown non-woven polypropylene, spun-bonded or melt-blown polyester, spun-bonded nylon web, spun-bonded or melt-blown polyethylene and combinations thereof.

5) The liquid infusion pod of claim 2 wherein the permeability of the first region is decreased relative to the permeability of the unaltered region.

6) The liquid infusion pod of claim 1 wherein the first region of the first filter member is created by embossing at least a portion of the first filter member.

7) The liquid infusion pod of claim 1 wherein the first region of the first filter member is created by laminating at least a portion of the first filter member.

8) The liquid infusion pod of claim 1 wherein the first region of the first filter member is created by coating at least a portion of the first filter member.

9) The liquid infusion pod of claim 7 wherein the laminate is selected from the group consisting of foil, plastic and combinations thereof.

10) The liquid infusion pod of claim 8 wherein the coating is a water soluble material.

11) The liquid infusion pod of claim 10 wherein the water soluble material is selected from the group consisting of ethyl vinyl alcohol, starch and combinations thereof.

12) The liquid infusion pod of claim 3 wherein the first region accounts for from about 5% to about 85% of the area of the first filter member.

13) The liquid infusion pod of claim 1 having a dissolution of the liquid dispersible material of at least about 50% in less than about 180 seconds.

14) The liquid infusion pod of claim 2 wherein the permeability of the first filter member is less than about 250 cfm/ft.

15) A liquid infusion pod comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, wherein the permeability of the first filter member is less than about 250 cfm/ft.

16) The liquid infusion pod of claim 15 wherein the first filter member comprises at least one first region and at least one second region and wherein the permeability of the first region is different from the permeability of the second region.

17) The liquid infusion pod of claim 16 wherein the first region is created by a method selected from the group consisting of embossing the first filter member, laminating the first filter member, coating the first filter member and combinations thereof.

18) A liquid infusion pod comprising a fluid distribution member situated in a top plane and a liquid permeable first filter member wherein the first filter member is sealed to the fluid distribution member forming a first interior chamber that comprises a liquid dispersible material, the fluid distribution member comprising at least one injection nozzle protruding downward from the top plane into the interior chamber, the injection nozzle has at least one infusion port that directs fluid into the first interior chamber in a direction that is not normal to the top plane, the first filter member comprising a permeability of less than about 250 cfm/ft² and at least one first region and at least one second region wherein the permeability of the first region is decreased relative to the permeability of the second region.

19) The liquid infusion pod of claim 18 wherein the first region is created by a method selected from the group consisting of embossing the first filter member, laminating the first filter member, coating the first filter member and combinations thereof.

20) The liquid infusion pod of claim 18 wherein the first region accounts for from about 5% to about 85% of the area of the first filter member.
